(19) United States
(12) Patent Application Publication
(10) Pub. No.: US 2003/0188298 A1
(43) Pub. Date: Oct. 2, 2003

(54) Test coverage framework

(75) Inventor: Roman Shaposhnick, Redwood Shores, CA (US)

Correspondence Address: David B. Ritchie, THELEN REID & PRIEST LLP, P.O. Box 640640, San Jose, CA, 95164, US

(73) Assignee: Sun Microsystems, Inc., a Delaware Corporation

(21) Appl. No.: 10/112,154

(22) Filed: Mar. 29, 2002

(51) Int. Cl. G06F 9/45

(52) U.S. Cl. 717/141

(57) ABSTRACT

A centralized database and test coverage framework tools are provided to allow developers to conduct sophisticated test coverage analysis. When testing of application code occurs, information regarding line execution by each of the tests is stored in a database file unique to the corresponding test. The information contains details on how many times each line was executed during the corresponding test. The database files each may be stored in a unique subdirectory and may be grouped in clusters specified by a developer. The storing may include executing a general purpose data collector with a database location and a cluster name as parameters. Then, test coverage results may be displayed to a user by presenting the application code. A corresponding number of executions for any line in the application code which is clicked on by a user may be displayed. This allows for dynamic source code navigation.

### FIELD OF THE INVENTION

The present invention relates to the field of virtual machines. More particularly, the present invention relates to a mechanism for establishing a relationship between parts of source code to provide a test coverage framework.

### BACKGROUND OF THE INVENTION

In computer science, testing of source code is very important in order to deliver a bug-free application to customers. Test coverage refers to the statistical analysis of how well the tests are being run on a particular piece of source code. Line-level test coverage tracks which lines of code are executed, and which are not. These results are often presented in a data structure showing the line identifiers in one column and number of executions in another column. This data may then be easily analyzed to arrive at a test coverage percentage indicating the percentage of executed lines. If that percentage is sufficiently low, the data structure may be further examined and the exact source code lines that were unexecuted can be examined to determine why they had not been tested.

FIG. 1 is a diagram illustrating an example of conventional test coverage analysis. Source code 100 contains a series of lines 102. When testing occurs, the number of times each line is executed is stored in data structure 104 having a column indicating number of executions 106 and a column indicating line number 108.

The drawback of traditional test coverage, however, is that it only results in a single percentage indicating the overall quality of testing. This is because the results of various test runs are all reported in a single cumulative results data structure. FIG. 2 is a diagram illustrating how results from tests are normally compiled for test coverage analysis after test execution. Each test that is run 200, 202, 204 produces test coverage results which are stored cumulatively 206.

It would be much more advantageous to be able to measure test-by-test distinctions. This would allow a developer to more accurately determine why certain lines in the source code are unexecuted. It would also allow a developer to weight tests according to importance. For example, test 1 200 may be much more vital to the successful operation of the application than test 2. Combining the results of both tests together into a single test coverage number might give an incorrect picture of how the application is performing.

Additionally, all subsequent accesses (and additions) to the combined data require that the entire file be fetched into memory. This results in a significant decrease in speed for every test after the first one.

What is needed is a solution that allows for more sophisticated test coverage analysis than prior art solutions.

### BRIEF DESCRIPTION OF THE INVENTION

A centralized database and test coverage framework tools are provided to allow developers to conduct sophisticated test coverage analysis. When testing of application code occurs, information regarding line execution by each of the tests is stored in a database file unique to the corresponding test. The information contains details on how many times each line was executed during the corresponding test. The database files each may be stored in a unique subdirectory and may be grouped in clusters specified by a developer. The storing may include executing a general purpose data collector with a database location and a cluster name as parameters. Then, test coverage results may be displayed to a user by presenting the application code. A corresponding number of executions for any line in the application code which is clicked on by a user may be displayed. This allows for dynamic source code navigation.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating an example of conventional test coverage analysis.

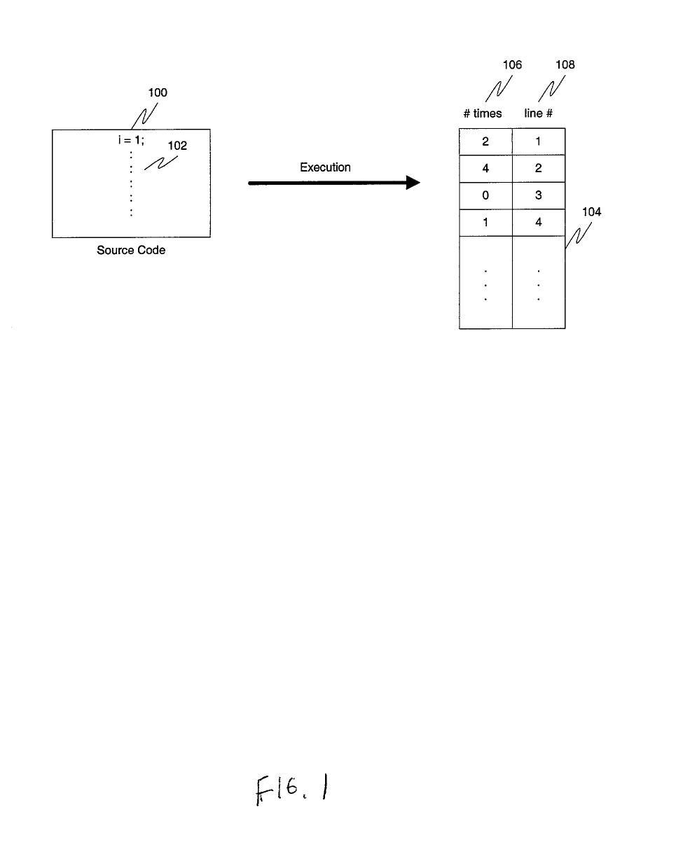

FIG. 2 is a diagram illustrating how results from tests are normally compiled for test coverage analysis after test execution.

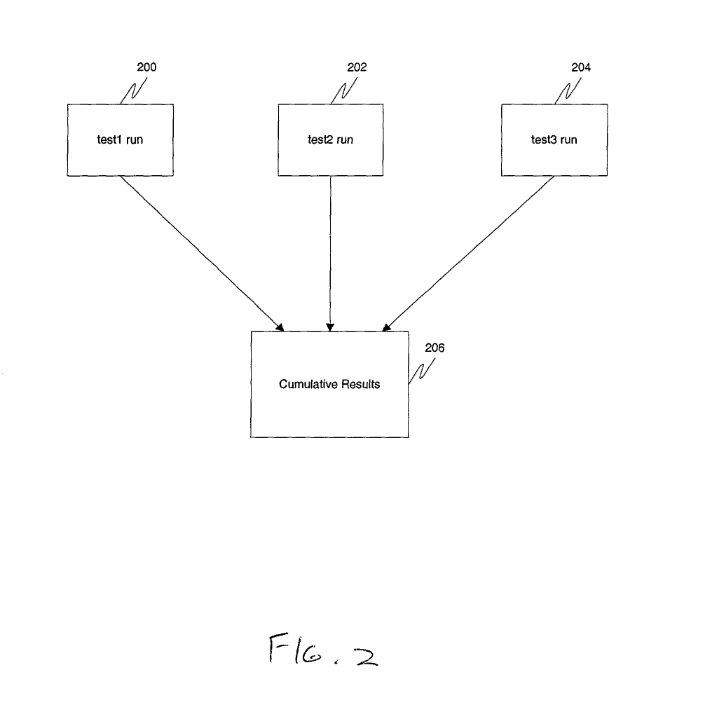

FIG. 3 is a flow diagram illustrating a method for conducting test coverage analysis of application code, the application code having one or more lines, in accordance with a specific embodiment of the present invention.

FIG. 4 is a block diagram illustrating an apparatus for conducting test coverage analysis of application code, the application code having one or more lines, in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Throughout this application, lines and line numbers of software applications are discussed. It should be noted that one of ordinary skill in the art will recognize that the present invention could also be applied to blocks of code larger than a single line (e.g., instead of lines and line numbers, it can be used for basic blocks and basic block numbers). Nothing in the present application should be construed to limit implementation to line numbers.

The present invention comprises a series of software tools that allow developers to conduct sophisticated test coverage analysis. The software tools may collectively be referred to as a test coverage framework.

In accordance with a specific embodiment of the present invention, a centralized database may comprise two main index files. A first index file holds information about all lines encountered by the process using the database. The index file holds the information about a line even though it may not be covered by any particular test. Rather than store full information about each line however, this file serves as a reference tool for accessing individual files storing more detailed information about each line. A second index file holds names of all source files.

Furthermore, the centralized database may also comprise content that can be subdivided into clusters or experiments for holding individual results or can simply hold content in the form of numbered subdirectories, each subdirectory representing a test. For example, if four tests are executed, there may be a subdirectory for each test, and the files representing the results of each of the tests may be stored within the subdirectories. Additionally, the subdirectories may be grouped as clusters of one or more tests that the user specifies. This is valuable for situations where multiple tests are required for a specific subsystem. For example, while four tests may be run on a particular application, it may be that the first two tests correspond to how the application acts in relation to interaction with part A and the second two tests correspond to how the application acts in relation to interaction with part B. The first two tests may then be grouped in a first cluster and the second two tests may be grouped in a second cluster.

In accordance with a specific embodiment of the present invention, several tools are provided that work with the database. A general purpose data collector may be used to populate the database with information about a single testrun. In a specific embodiment of the present invention, the tcover command may be used for this purpose and may have the following syntax:

$ tcover [−d <DB location>] [−c <cluster name>] command [parameters]

where <DB location> is the name of the directory that holds the main portion of the directory with which the user wants to work and <cluster name> is the subdirectory in which results should be placed.

When the general purpose data collector is executed, the software product being tested is run in the usual manner, except that it is augmented with additional trace information by the compiler. This trace may then be taken, converted, and paced into the database. Part of this trace may be placed into tcovd.bin, parts in bblocks.index, and parts in files.index.

A file coverage tool, which acts as a fine-grained report generator, may be used for displaying test coverage information based on results currently available in the database. In a specific embodiment of the present invention, the syntax may be:

| $ file_coverage | [−d <DB location>] [−c <experiment name>] |
|---|---|
| | [−e <test set spec>] [−f <file set spec>] |
| <test set spec> may be an ASCII string that specifies a subset of | |
| integers having the following syntax: | |
| test set spec: | linear-spec [,linear-spec]* |
| linear-spec: | point-spec \| segment-spec |
| segment-spec: | point-spec “-”point-spec |
| point-spec: | <decimal-number> |

It may be used to restrict reporting to only a subset of all results available. For example, specifying −e 1-10, 70-100 will count only results from 1 through 10 and 70 through 100.

<file set spec> may be an ASCII string that may be used to restrict reporting to only files with names containing the specified string. Additionally, if the first symbol in the string is “%”, reporting may be restricted to the files with index numbers mentioned in <test set spec>, thus specifying −f ‘%70-100’ will give results with indexes from 70 to 100.

The file coverage tool scans through the database and finds results matching the criteria given in the parameters. Then it displays the results to the user.

A line coverage tool may be used as a line-grained report generator to provide detailed analysis of one or more source files. In a specific embodiment of the present invention, it may have the following syntax:

$ line_coverage [−d < DB location>] [−c <experiment name>]

[−e <test set spec>] [−f <file set spec>]

The options are the same as discussed in previous sections. Thus, the following example may be used:

$ line_coverage -d /tmp/DB -f foo_bar.cc

<only a part of output is shown>

static string
find_ours (const char* name)

| 1 -> { | |
|---|---|
| | string libpath = ′ ″; |
| | char path [MAXPATHLEN+1]; |
| 1 -> | if(name) |

| | |
|---|---|
| ###### -> | std_libname (*librtld_db.so.1″); |

In this example, the function has been executed one time, although the line with ##### on it has not been executed at all. If multiple files are specified by the option −f, then they may be delimited in the resulting output by “----------------------”.

The line coverage tool scans through the database and finds results matching the criteria given in the parameters. Then it displays the results to the user.

A general purpose lookup tool may also be provided to locate tests which have executed a given line in a given file. It may take the syntax:

| | |
|---|---|
| $ tcovd_find | [−d <DB location>] [−c <experiment name>] |
| | [−e <test set spec>] <file id> [<line id>] |

This tool allows a programmer to figure out what test has executed a particular piece of source code and allows a static mechanism for debugging code. Thus, an example run of:

$ tcovd_find −d/tmp/DB 2 13 may result in the output:

1

13

112

indicating that line 13 in the file with index 2 has been touched only by tests 1, 13, and 112.

When the general purpose lookup tool is executed, the datafile for every single test is considered and if it has a specified basic block and file name mentioned in it, then the name of the subdirectory where this data resides is printed.

A comparison tool may be used to further examine coverage data. In a specific embodiment of the present invention, the syntax may be:

$1 tcovd_diff [−d <DB location>] [−c <experiment name>] [−f <file set spec>]

<test set specification #1> <test set specification #2>

The output may be file(s) specified by the −f with the following symbols on the left margin if appropriate:

1. ###-> line untouched by both sets of tests

2. <percentage % tests specified by test set specification #1 touch this line percentage % less than tests from test set specification #2

3. >percentage % tests specified by test set specification #2 touch this line percentage % les than tests from test set specification #1

4. <<<-> tests specified by test set specification #1 don't touch this line at all, while tests from test set specification #2 do.

5. >>>-> tests specified by test set specification #2 don't touch this line at all, while tests from test set specification #1 do.

Thus the following output may occur:

$ tcovd_diff -d /tmp/DB -f foo_bar.cc “1” “2”

<only a part of output is shown>

| | static string |
|---|---|
| | find_ours (const char* name) |
| <18% ->{ | |
| | string libpath = “ ” |
| | char path (MAXPATHLEN+1]; |
| <<< -> | if(name) |

| | |
|---|---|
| ### -> | std_libname(“librtld_db.so.1”); |

Thus, by executing test #2 there is 18% coverage of the function “find_ours”, as well as at least some coverage of “if (name)”, and the std_libname call is untouched.

The comparison tool, when executed, works similarly to the line coverage tool. The main difference is that it uses data from two sets of tests to augment the source code.

In a specific embodiment of the present invention, a user interface may be provided that allows the programmer to take advantage of dynamic source code navigation. Here, lines of the source code itself may be clicked using a mouse, and the corresponding number of executions for that line may appear on the screen.

When a user clicks on a left margin, Common Gateway Interface (CGI) script is executed and invokes a lookup tool. The raw ASCII results are then translated to the appropriate HTTP links to the particular tests involved.

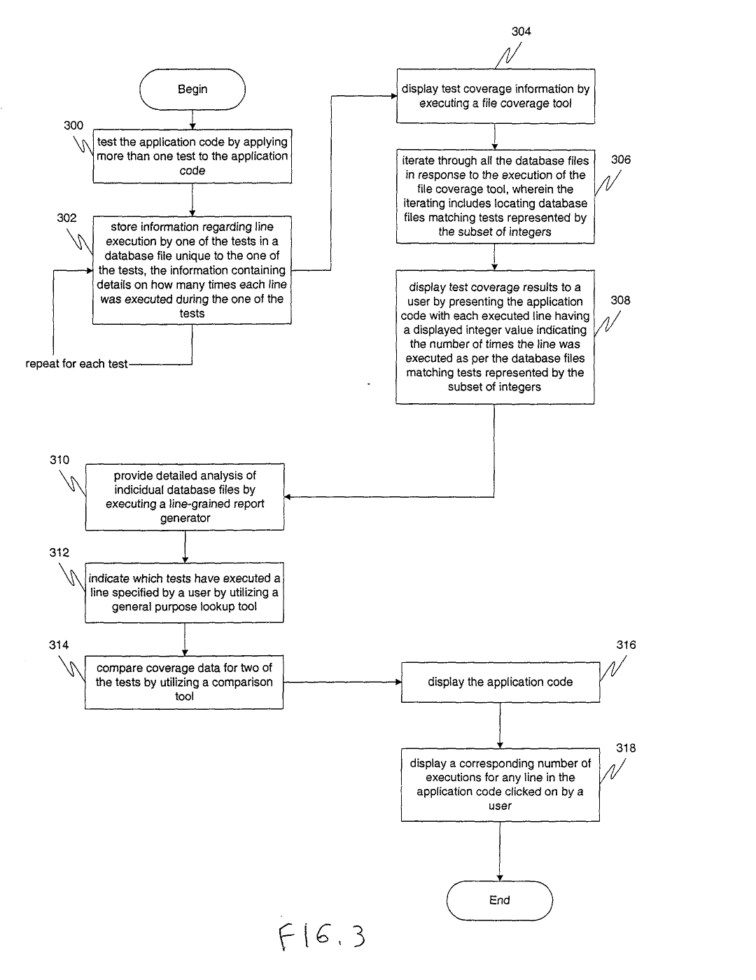

FIG. 3 is a flow diagram illustrating a method for conducting test coverage analysis of application code, the application code having one or more lines, in accordance with a specific embodiment of the present invention. At 300, the application code is tested by applying more than one test to the application code. At 302, information regarding line execution by one of the tests is stored in a database file unique to the one of the tests, the information containing details on how many times each line was executed during the one of the tests. Each of the database files may be stored in a unique directory. The database files may also be grouped into clusters specified by a user. The storing may include executing a general purpose data collector with a database location and a cluster name as parameters. 302 is repeated for each of the tests.

At 304, test coverage information may be displayed by executing a file coverage tool. The file coverage tool may include a string specifying a subset of integers representing which of the tests to include in the test coverage analysis. The file coverage tool may also include a parameter holding a string specifying a name indicating that only database files having names containing the name be included in the test coverage analysis. Additionally, the file coverage tool may include a parameter holding a string specifying a subset of integers indicating that only database files having index numbers within said subset of integers be included in the test coverage analysis. At 306, all the database files are iterated through in response to the execution of the file coverage tool, wherein the iterating includes locating database files matching tests represented by the subset of integers. At 308, test coverage results are displayed to a user by presenting the application code with each executed line having a displayed integer value indicating the number of times the line was executed as per the database files matching tests represented by the subset of integers. At 310, detailed analysis of individual database files may be provided by executing a line-grained report generator, wherein the executing a line-grained report generator includes displaying results of an individual database file by presenting the application code with each executed line having a displayed integer value indicating the number of times the line was executed as per the individual database file. At 312, which tests have executed a line specified by a user may be indicated by utilizing a general purpose lookup tool. At 314, coverage data for two of the tests may be compared by utilizing a comparison tool. At 316, the application code may be displayed and at 318, a corresponding number of executions for any line in the application code clicked on by a user may be displayed.

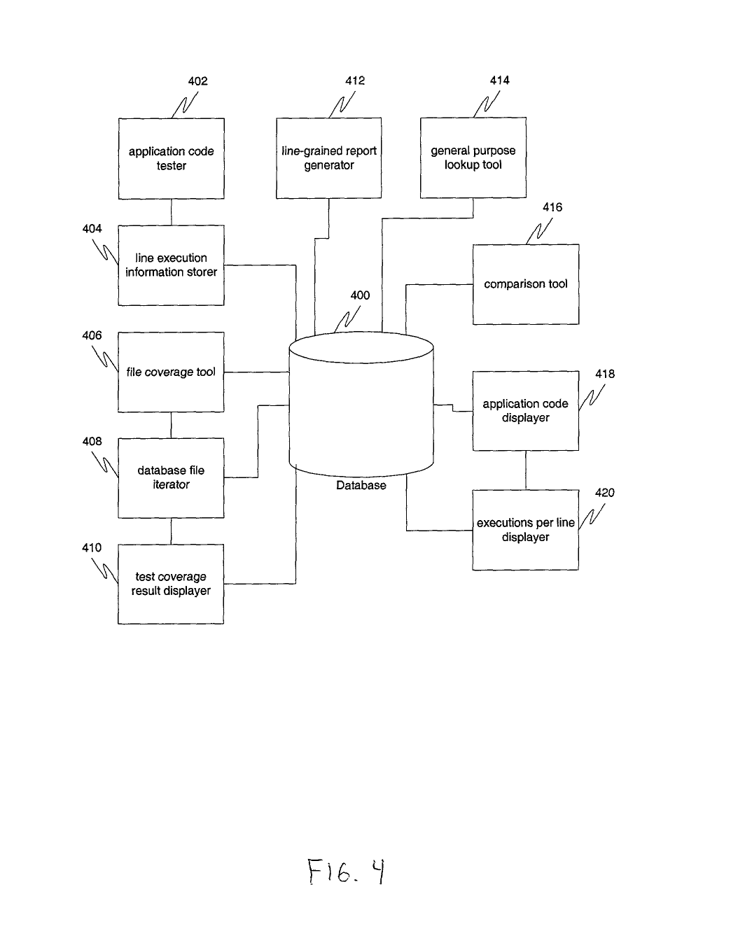

FIG. 4 is a block diagram illustrating an apparatus for conducting test coverage analysis of application code, the application code having one or more lines, in accordance with a specific embodiment of the present invention. A database 400 may be used for storing information. An application code tester 402 may test the application code by applying more than one test to the application code. A line execution information storer 404 coupled to the database 400 and to the application code tester 402 stores information regarding line execution by one of the tests in a database file unique to the one of the tests, the information containing details on how many times each line was executed during the one of the tests. Each of the database files may be stored in a unique directory. The database files may also be grouped into clusters specified by a user. The storing may include executing a general purpose data collector with a database location and a cluster name as parameters. This is then repeated for each of the tests.

A file coverage tool 406 coupled to the database 400 may be executed to display test coverage information. The file coverage tool 406 may include a string specifying a subset of integers representing which of the tests to include in the test coverage analysis. The file coverage tool 406 may also include a parameter holding a string specifying a name indicating that only database files having names containing the name be included in the test coverage analysis. Additionally, the file coverage tool may 406 include a parameter holding a string specifying a subset of integers indicating that only database files having index numbers within said subset of integers be included in the test coverage analysis. A database file iterator 408 coupled to the database 400 and to the file coverage tool 406 may iterate through all the database files in response to the execution of the file coverage tool, wherein the iterating includes locating database files matching tests represented by the subset of integers. A test coverage result displayer 410 coupled to the database 400 and to the database file iterator 408 may test coverage results to a user by presenting the application code with each executed line having a displayed integer value indicating the number of times the line was executed as per the database files matching tests represented by the subset of integers. A line-grained report generator 412 coupled to the database 400 may provide detailed analysis of individual database files, including displaying results of an individual database file by presenting the application code with each executed line having a displayed integer value indicating the number of times the line was executed as per the individual database file. A general purpose lookup tool 414 coupled to the database 400 indicates which tests have executed a line specified by a user. A comparison tool 416 coupled to the database 400 may compare coverage data for two of the tests. An application code displayer 418 coupled to the database 400 may display the application code and an executions per line displayer 420 coupled to the database 400 and to the application code displayer 418 may display a corresponding number of executions for any line in the application code clicked on by a user.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for conducting test coverage analysis of application code, the application code having one or more lines, the method comprising:
testing the application code by applying more than one test to the application code;
storing information regarding line execution by one of said tests in a database file unique to said one of said tests, said information containing details on how many times each line was executed during said one of said tests; and
repeating said storing for each of said tests.

2. The method of claim 1, wherein each of said database files is stored in a unique subdirectory.

3. The method of claim 1, further including grouping said database files in clusters specified by a user.

4. The method of claim 1, wherein said storing comprises executing a general purpose data collector with a database location and a cluster name as parameters.

5. The method of claim 1, further comprising displaying test coverage information by executing a file coverage tool.

6. The method of claim 5, wherein said file coverage tool includes a parameter holding an string specifying a subset of integers representing which of said tests to include in the test coverage analysis.

7. The method of claim 6, further including:
iterating through all of said databases files in response to said execution of said file coverage tool, wherein said iterating includes locating database files matching tests represented by said subset of integers; and
displaying test coverage results to a user by presenting the application code with each executed line having a displayed integer value indicating the number of times said line was executed as per said database files matching tests represented by said subset of integers.

8. The method of claim 5, wherein said file coverage tool includes a parameter holding a string specifying a name indicating that only database files having names containing said name be included in the test coverage analysis.

9. The method of claim 5, wherein said file coverage tool includes a parameter holding a string specifying a subset of integers indicating that only database files having index numbers within said subset of integers be included in the test coverage analysis.

10. The method of claim 1, further comprising providing detailed analysis of individual database files by executing a line-grained report generator, wherein said executing a line-grained report generator includes displaying results of an individual database file by presenting the application code with each executed line having a displayed integer value indicating the number of times said line was executed as per said individual database file.

11. The method of claim 1, further comprising indicating which tests have executed a line specified by a user by utilizing a general purpose lookup tool.

12. The method of claim 1, further comprising comparing coverage data for two of said tests by utilizing a comparison tool.

13. The method of claim 12, further including;
displaying the application code; and
displaying a corresponding number of executions for any line in the application code clicked on by a user.

14. A method for conducting test coverage analysis of application code, the application code having one or more basic blocks, the method comprising:
testing the application code by applying more than one test to the application code;
storing information regarding line execution by one of said tests in a database file unique to said one of said tests, said information containing details on how many times each basic block was executed during said one of said tests; and
repeating said storing for each of said tests.

15. The method of claim 14, wherein each of said database files is stored in a unique subdirectory.

16. The method of claim 14, further including grouping said database files in clusters specified by a user.

17. The method of claim 14, wherein said storing comprising executing a general purpose data collector with a database location and a cluster name as parameters.

18. The method of claim 14, further comprising displaying test coverage information by executing a file coverage tool.

19. The method of claim 18, wherein the file coverage tool includes a parameter holding an string specifying a subset of integers representing which of said tests to include in the test coverage analysis.

20. The method of claim 19, further including:
iterating through all of said databases files in response to said execution of said file coverage tool, wherein said iterating includes locating database files matching tests represented by said subset of integers; and
displaying test coverage results to a user by presenting the application code with each executed basic block having a displayed integer value indicating the number of times said basic block was executed as per said database files matching tests represented by said subset of integers.

21. The method of claim 18, wherein the file coverage tool includes a parameter holding a string specifying a name indicating that only database files having names containing said name be included in the test coverage analysis.

22. The method of claim 18, wherein the file coverage tool includes a parameter holding a string specifying a subset of integers indicating that only database files having index numbers within said subset of integers be included in the test coverage analysis.

23. The method of claim 14, further comprising providing detailed analysis of individual database files by executing a line-grained report generator, wherein said executing a basic-block-grained report generator includes displaying results of an individual database file by presenting the application code with each executed basic block having a displayed integer value indicating the number of times said basic block was executed as per said individual database file.

24. The method of claim 14, further comprising indicating which tests have executed a basic block specified by a user by utilizing a general purpose lookup tool.

25. The method of claim 14, further comprising comparing coverage data for two of said tests by utilizing a comparison tool.

26. The method of claim 25, further including;
displaying the application code; and
displaying a corresponding number of executions for any basic block in the application code clicked on by a user.

27. An apparatus for conducting test coverage analysis of application code, the application code having one or more lines, the apparatus comprising:
a database;
an application code tester; and
a line execution information storer coupled to said database and to said application code tester.

28. The apparatus of claim 27, further including a file coverage tool coupled to said database.

29. The apparatus of claim 28, further including a database file iterator coupled to said database and to said file coverage tool.

30. The apparatus of claim 29, further including a test coverage result displayer coupled to said database and to said database file iterator.

31. The apparatus of claim 27, further including a line-grained report generator coupled to said database.

32. The apparatus of claim 27, further including a general purpose lookup tool coupled to said database.

33. The apparatus of claim 27, further including a comparison tool coupled to said database.

34. The apparatus of claim 27, further including:
an application code displayer coupled to said database; and
an executions per line displayer coupled to said database and to said application code displayer.

35. An apparatus for conducting test coverage analysis of application code, the application code having one or more lines, the apparatus comprising:
means for testing the application code by applying more than one test to the application code;
means for storing information regarding line execution by one of said tests in a database file unique to said one of said tests, said information containing details on how many times each line was executed during said one of said tests; and
means for repeating said storing for each of said tests.

36. The apparatus of claim 35, wherein each of said database files is stored in a unique subdirectory.

37. The apparatus of claim 35, further including means for grouping said database files in clusters specified by a user.

38. The apparatus of claim 35, wherein said means for storing comprises means for executing a general purpose data collector with a database location and a cluster name as parameters.

39. The apparatus of claim 35, further comprising means for displaying test coverage information by executing a file coverage tool.

40. The apparatus of claim 39, wherein said file coverage tool includes a parameter holding an string specifying a subset of integers representing which of said tests to include in the test coverage analysis.

41. The apparatus of claim 40, further including:
means for iterating through all of said databases files in response to said execution of said file coverage tool, wherein said iterating includes locating database files matching tests represented by said subset of integers; and
means for displaying test coverage results to a user by presenting the application code with each executed line having a displayed integer value indicating the number of times said line was executed as per said database files matching tests represented by said subset of integers.

42. The apparatus of claim 39, wherein said file coverage tool includes a parameter holding a string specifying a name indicating that only database files having names containing said name be included in the test coverage analysis.

43. The apparatus of claim 39, wherein said file coverage tool includes a parameter holding a string specifying a subset of integers indicating that only database files having index numbers within said subset of integers be included in the test coverage analysis.

44. The apparatus of claim 35, further comprising means for providing detailed analysis of individual database files by executing a line-grained report generator, wherein said executing a line-grained report generator includes displaying results of an individual database file by presenting the application code with each executed line having a displayed integer value indicating the number of times said line was executed as per said individual database file.

45. The apparatus of claim 35, further comprising means for indicating which tests have executed a line specified by a user by utilizing a general purpose lookup tool.

46. The apparatus of claim 35, further comprising means for comparing coverage data for two of said tests by utilizing a comparison tool.

47. The apparatus of claim 46, further including;
means for displaying the application code; and
means for displaying a corresponding number of executions for any line in the application code clicked on by a user.

48. An apparatus for conducting test coverage analysis of application code, the application code having one or more basic blocks, the apparatus comprising:
means for testing the application code by applying more than one test to the application code;
means for storing information regarding line execution by one of said tests in a database file unique to said one of said tests, said information containing details on how many times each basic block was executed during said one of said tests; and
means for repeating said storing for each of said tests.

49. The apparatus of claim 48, wherein each of said database files is stored in a unique subdirectory.

50. The apparatus of claim 48, further including means for grouping said database files in clusters specified by a user.

51. The apparatus of claim 48, wherein said means for storing comprises means for executing a general purpose data collector with a database location and a cluster name as parameters.

52. The apparatus of claim 48, further comprising means for displaying test coverage information by executing a file coverage tool.

53. The apparatus of claim 52, wherein said file coverage tool includes a parameter holding an string specifying a subset of integers representing which of said tests to include in the test coverage analysis.

54. The apparatus of claim 53, further including:
means for iterating through all of said databases files in response to said execution of said file coverage tool, wherein said iterating includes locating database files matching tests represented by said subset of integers; and
means for displaying test coverage results to a user by presenting the application code with each executed basic block having a displayed integer value indicating the number of times said basic block was executed as per said database files matching tests represented by said subset of integers.

55. The apparatus of claim 52, wherein said file coverage tool includes a parameter holding a string specifying a name indicating that only database files having names containing said name be included in the test coverage analysis.

56. The apparatus of claim 52, wherein said file coverage tool includes a parameter holding a string specifying a subset of integers indicating that only database files having index numbers within said subset of integers be included in the test coverage analysis.

57. The apparatus of claim 48, further comprising means for providing detailed analysis of individual database files by executing a line-grained report generator, wherein said executing a basic-block-grained report generator includes displaying results of an individual database file by presenting the application code with each executed basic block having a displayed integer value indicating the number of times said basic block was executed as per said individual database file.

58. The apparatus of claim 48, further comprising means for indicating which tests have executed a basic block specified by a user by utilizing a general purpose lookup tool.

59. The apparatus of claim 48, further comprising means for comparing coverage data for two of said tests by utilizing a comparison tool.

60. The apparatus of claim 59, further including;
means for displaying the application code; and
means for displaying a corresponding number of executions for any basic block in the application code clicked on by a user.

61. A program storage device readable by a machine, tangibly embodying a program of instructions executable by the machine to perform a method for conducting test coverage analysis of application code, the application code having one or more lines, the method comprising:
testing the application code by applying more than one test to the application code;
storing information regarding line execution by one of said tests in a database file unique to said one of said tests, said information containing details on how many times each line was executed during said one of said tests; and
repeating said storing for each of said tests.

62. A program storage device readable by a machine, tangibly embodying a program of instructions executable by the machine to perform a method for conducting test coverage analysis of application code, the application code having one or more basic blocks, the method comprising:
testing the application code by applying more than one test to the application code;
storing information regarding line execution by one of said tests in a database file unique to said one of said tests, said information containing details on how many times each basic block was executed during said one of said tests; and
repeating said storing for each of said tests.
